(19) United States
(12) Patent Application Publication
(10) Pub. No.: US 2024/0336272 A1
(43) Pub. Date: Oct. 10, 2024

(54) CONTROL MACHINE LEARNING MODEL RESOURCE CONSUMPTION IN A VEHICLE

(71) Applicant: Rivian IP Holdings, LLC, Plymouth, MI (US)

(72) Inventors: Rajeev Patwari, San Jose, CA (US); Bradley Lester Taylor, Santa Cruz, CA (US)

(21) Appl. No.: 18/297,713

(22) Filed: Apr. 10, 2023

(51) Int. Cl. B60W 50/04

(52) U.S. Cl. CPC B60W 50/045; B60W 2050/0013

(57) ABSTRACT

A system can include a data processing system. The data processing system can include memory devices coupled with one or more processors. The data processing system can receive a model trained by machine learning comprising first operations, the model to generate an output to operate a vehicle. The data processing system can search the model to identify a non-linear operation of the first operations. The data processing system can select, from second operations, a second operation that approximates the non-linear operation, the selection based on a level of computing resources consumed by the second operations, an accuracy of the model generated with the second operations, and an accuracy threshold to operate the vehicle. The data processing system can replace the non-linear operation with the second operation in the model to produce a second output.

### INTRODUCTION

A vehicle can include a processor and a battery system. The processor of the vehicle can operate the vehicle based on power received from the battery system.

### SUMMARY

This technical solution is directed to techniques for controlling (e.g., reducing) machine learning model resource consumption for a machine learning model used in a vehicle system (e.g., an autonomous driving system, an advanced driver assistance system (ADAS), a collision avoidance system, a lane assist system). The present solution can identify and replace resource intensive operations of a machine learning model (e.g., non-linear operations) with operations that approximate the resource intensive operation and consume less resources. For example, linear operations can reduce the processing resources used to implement non-linear operations in the machine learning model. Because multiple linear approximations may exist for approximating a given non-linear operation, and each approximation may provide a different level of model accuracy and consume a different level of computing resources, the system can perform experiments, simulations, or optimizations to test operations in the machine learning model. The system can implement an objective function (e.g., a cost function or loss function) to select one second operation to approximate a first resource intensive operation. The objective function can be optimized based on accuracy metrics of the model with each second operation and processing resource metrics for each second operation. Based on the optimization, the second operation can be selected. Responsive to selecting a second operation to replace the first operation, the system can transform the machine learning model into a lower computationally intensive model by replacing the first operation with the second operation. The updated model can then be deployed to a vehicle for execution or implementation.

At least one aspect is directed to a system. The system can include a data processing system. The data processing system can include memory devices coupled with one or more processors. The data processing system can receive a model trained by machine learning including first operations, the model to generate an output to operate a vehicle. The data processing system can search the model to identify a non-linear operation of the first operations. The data processing system can select, from second operations, a second operation that approximates the non-linear operation, the selection based on a level of computing resources consumed by the second operations, an accuracy of the model generated with the second operations, and an accuracy threshold to operate the vehicle. The data processing system can replace the non-linear operation with the second operation in the model to produce a second output.

At least one aspect is directed to a method. The method can include receiving, by a data processing system including memory devices coupled with one or more processors, a model trained by machine learning including first operations, the model to generate an output to operate a vehicle. The method can include searching, by the data processing system, the model to identify a non-linear operation of the first operations. The method can include selecting, by the data processing system, from second operations, a second operation that approximates the non-linear operation, the selection based on a level of computing resources consumed by the second operations, an accuracy of the model generated with the second operations, and an accuracy threshold to operate the vehicle. The method can include replacing, by the data processing system, the non-linear operation with the second operation in the model to produce a second output.

At least one aspect is directed to a vehicle. The vehicle can include a data processing system including memory devices coupled with one or more processors. The data processing system can receive a model trained by machine learning including first operations. The model can be transformed to replace a non-linear operation of the model with a second operation of second operations. The second operation can be selected from the second operations to approximate the non-linear operation. The selection can be based on a level of computing resources consumed by the second operations, an accuracy of the model generated with the second operations, and an accuracy threshold to operate the vehicle. The data processing system can receive sensor data from at least one sensor of the vehicle. The data processing system can execute the model with the sensor data as an input to generate an output to operate the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system that adjusts the computing resource consumption of a machine learning model.

FIG. 2 depicts an example machine learning model that includes operations replaced by operations that consume less computing resources.

FIG. 3 depicts an example table indicating resource consumption and accuracy of linear operations that approximate non-linear operations of a machine learning model.

FIG. 4 depicts an example table indicating accuracy and resource consumption for multiple operations that approximate a particular operation of a machine learning model.

FIG. 5 depicts an example chart plotting accuracy and resource consumption for multiple operations that approximate a particular operation of a machine learning model.

FIG. 6 depicts an example vehicle including a data processing system that executes a machine learning model.

FIG. 7 depicts an example method of reducing the computing resource consumption of a machine learning model.

FIG. 8 depicts another example method of reducing the computing resource consumption of a machine learning model.

FIG. 9 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of adjusting machine learning model resource consumption. The various concepts introduced above and discussed in greater detail below may be implemented in any of numerous ways.

This disclosure is generally directed to techniques for adjusting (e.g., reducing, maintaining, managing, or otherwise controlling) machine learning model resource consumption for machine learning models used in a vehicle system (e.g., an autonomous driving system, an advanced driver assistance system (ADAS), a collision avoidance system, a lane assist system). The techniques described herein can optimize a machine learning neural network model by categorically approximating non-linear operations to reduce latency and power and also to increase model performance. The technical solution can facilitate thermal management by reducing power consumption by processors and other circuitry of the vehicle. A machine learning model, such as a neural network, that is deployed to a data processing system of a vehicle can have one or more criteria to provide high performance and accuracy but operate on a limited amount of processing resources (e.g., processor resources, memory resources, power resources, integrated circuit footprint). A neural network can include linear and non-linear layers or operations. Linear operations can include matrix multiplication or convolution. Non-linear operations can include SoftMax, SiLU, or GeLU. To implement the non-linear operations of a neural network, a graphics processing unit (GPU) or central processing unit (CPU) may use a mathematical software library that consumes significant amounts of computational resources. The linear operations can use significantly less processing resources than the non-linear operations.

To solve these and other technical problems, the present solution can identify and replace non-linear operations of a machine learning model with linear operations that approximate the non-linear operations. The linear operations can reduce the processing resources used to implement the machine learning model. Because multiple linear approximations can exist for a given non-linear operation, and each approximation can provide a different level of model accuracy and consume a different level of computing resources, the system can perform experiments, simulations, or optimizations to test each operation and select the operations that satisfies one or more criteria. The criteria can be that the replacement operation consumes processing resources less than a level and provides a model output with an accuracy level greater than a threshold. For example, the criteria may be to select an operation that utilizes the least amount of computing resources but provides an accuracy level greater than a threshold. An accuracy criteria can be based on an accuracy of an output of an overall model, or an output of a sub-model that is part of a larger model, when the model uses the linear approximation operation to generate the output.

The system can create, store, or receive a library of operations that approximate non-linear operations of a machine learning model. The system can receive a machine learning model and identify a first operation in the machine learning model that consumes processing resources greater than a threshold (e.g., identify a non-linear operation). The system can analyze second operations that approximate the first operation and determine which second operation to select as a replacement for the first operation. The system can implement an objective function (e.g., a cost function or loss function) to select one second operation to approximate the first resource intensive operation. The objective function can be optimized based on accuracy metrics of the model with each second operation and processing resource metrics for each second operation. Based on the optimization, the second operation can be selected. Responsive to selecting a second operation to replace the first operation, the system can transform the machine learning model into a lower computationally intensive model by replacing the first operation with the second operation. The updated model can then be deployed to a vehicle for execution or implementation.

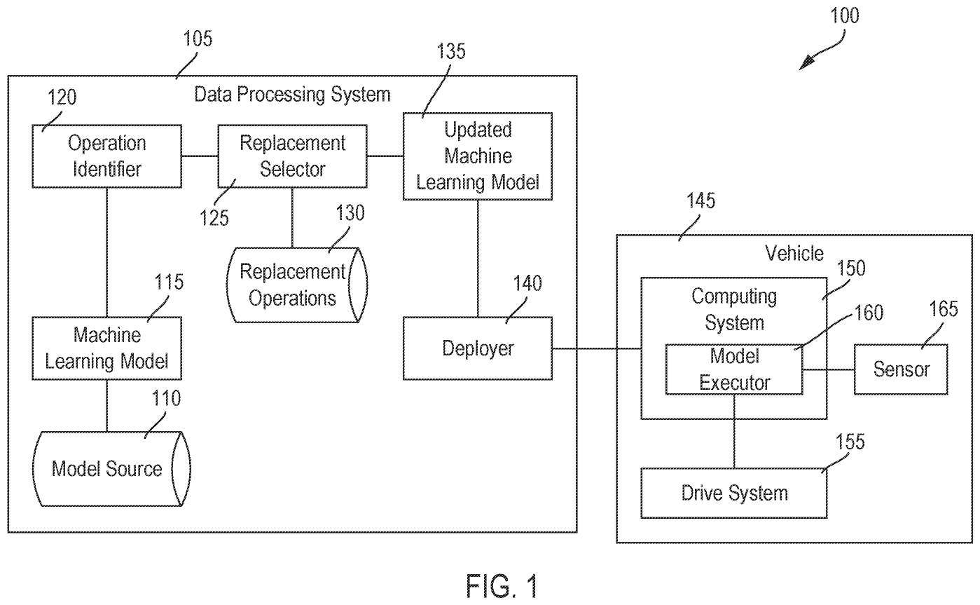

FIG. 1, among others, illustrates an example system 100 that adjusts or otherwise manages or controls the computing resource consumption of a machine learning model 115. The system 100 can include a data processing system 105. The system 100 can include a vehicle 145. The data processing system 105 can be a system, apparatus, or device. The data processing system 105 can be a server or server system, a computing system, a laptop computer, a desktop computer, one or multiple logic or processing circuits.

The data processing system 105 can receive at least one machine learning model 115. The machine learning model 115 can be a model trained based on at least one machine learning training technique (e.g., gradient descent, Newton method, conjugate gradient, quasi-Newton method, Levenberg-Marquardt algorithm). The machine learning model 115 can be a neural network. The neural network can be or include a convolutional neural network, a recurrent neural network, or a fusion network. The machine learning model 115 can implement, or can be used to implement autonomous driving, self-driving, ADAS features (e.g., collision avoidance, lane assist, cruise control, etc.).

The machine learning model 115 can be or include a collection or sequence of sub-models. For example, the machine learning model 115 can be or include a fusion network that fuses data of multiple sensors for autonomous driving. For example, the machine learning model 115 can include a BEV-Fusion network, a ResNet, a vision transformer, or a YOLOv5 network. The fusion network can concatenate multiple models together such that the output of one model is used as an input for another model. The fusion network can fuse multiple sensor inputs together for performing vehicle functions. For example, the fusion network can fuse camera data with radar data. The fusion network can create a highly dimensional world view surrounding a vehicle based on data from multiple different types of sensors, e.g., radar, cameras, light detection and ranging LIDAR, proximity sensors, acceleration sensors, speed sensors.

The machine learning model 115 can include layers, computations, nodes, or operations. The operations can receive input data and generate output data. The operations can be organized in the machine learning model 115 in a sequence. For example, the output of one operation can be an input into another operation. The operations can consume varying levels of resources (e.g., computing resources, processing resources, power consumption, length of time to complete). The operations can be non-linear operations or linear operations. The operations can execute based on retrieving data from lookup tables and multiplying the retrieved data with one or multiple coefficients. The machine learning model 115 can generate at least one output. The output can be used to control or operate a vehicle. For example, the output can be used in a control system to control speed of the vehicle, accelerate the vehicle, decelerate the vehicle, change or control direction of the vehicle, or brake the vehicle.

The machine learning model 115 can be or include a graph. The graph may be a data structure separate from the machine learning model 115 that represents the operations of the machine learning model 115. The graph can include nodes connected, interconnected, related, or linked via edges. Each node can be or represent a layer, computation, or operation of the machine learning model 115. The edges can represent the flow of information through the machine learning model 115. For example, a first node being connected to a second node can indicate that an output of an operation represented by the first node is used as an input to an operation represented by the second node.

The data processing system 105 can include at least one operation identifier 120. The operation identifier 120 can be a piece of software, a script, a function, an executable, instructions, or code. The operation identifier 120 can retrieve or receive the machine learning model 115 from a model source 110. The model source 110 can be a system that trains or stores the machine learning model 115. The model source 110 or the data processing system 105 can train or fully train the machine learning model 115 before the data processing system 105 replaces high resource consuming operations in the machine learning model 115 with lower resource consuming operations. The model source 110 can include one or multiple data sets for training, validating, or testing the machine learning model 115. The model source 110 can use a training data set to train the machine learning model 115, use a validation dataset to validate the machine learning model 115, and use a test dataset to test the machine learning model 115. Furthermore, the model source 110 can provide one of the datasets, for example, the validation data set, to the replacement selector 125. The replacement selector 125 can use the validation dataset to test various replacement operations 130 in the machine learning model 115.

The operation identifier 120 can perform a search of the machine learning model 115. For example, the operation identifier 120 can search the machine learning model 115 to identify operations that meet a criteria. The criteria may be that the operations consume processing resources greater than a threshold. For example, the operation identifier 120 can compare a lookup table size for each operation to a threshold and identify operations that include a lookup table greater than a threshold. The criteria can be a length of time it takes the operation to execute, a CPU or GPU utilization of the operation, etc. The criteria can be that the operation is a non-linear operation. Based on the search, the operation identifier 120 can identify at least one operation in the machine learning model 115 that is a resource intensive operation.

The data processing system 105 can include a replacement selector 125. The replacement selector 125 can be a piece of software, a script, a function, an executable, instructions, or code. The replacement selector 125 can select an operation to replace an identified operation in the machine learning model 115. For example, the replacement selector 125 can replace a first operation of the machine learning model 115 with a second operation. The second operation can consume, utilize, or require less processing resources than the first operation. For example, the replacement selector 125 can replace a non-linear operation in the machine learning model 115 with a linear operation.

There may be multiple different replacement operations 130 that can replace an identified operation in the machine learning model 115. The replacement selector 125 can search a library of available replacement operations 130 and identify a set of replacement operations 130 that can approximate or map to the identified operation. The library of replacement operations 130 can include various low resource consumption operations that can approximate or map to high resource consuming operations. For example, the library of replacement operations 130 can include linear operations that can approximate different types of non-linear operations. The library can map each type of non-linear operation to a set or group of linear operations that can approximate the non-linear operation. For example, the replacement selector 125 can receive an indication of a type of non-linear operation identified in the machine learning model 115. Responsive to receiving the indication of the non-linear operation, the replacement selector 125 can identify a set or group of replacement operations 130 and then search or optimize the set of replacement operations 130 to identify one replacement operation 130 to use in the machine learning model 115.

The computing system 105 can receive, generate, store, or develop a library, group, set, repository, or database of replacement operations 130. The library of replacement operations can be approximation schemes developed apriori. For example, the library of data processing system 105 can store the library of replacement operations 130 before the data processing system 105 analyzes the machine learning model 115 to transform the machine learning model 115 to the updated machine learning model 135. The library can be generated by the data processing system 105 based on resources and computing performance levels of the computing system 150 of the vehicle 145. The data processing system 105 can generate the library based on mathematical accuracy and precision used to execute the machine learning model 115 on the vehicle 145.

Each of the replacement operations 130 can consume a different level of processing resources. Furthermore, each of the replacement operations 130 may cause the machine learning model 115 to operate with a different accuracy. In this regard, the replacement selector 125 can identify a set of replacement operations 130 that can approximate or map to the identified operation and run an experiment, test, or simulation testing each replacement operation of the set of replacement operations 130 in the machine learning model 115. For example, the replacement selector 125 can select, from multiple second operations, a second operation that approximates the first operation. The selection can be based on a level of computing resources consumed by the second operations, an accuracy of the machine learning model 115 generated with the second operations, and an accuracy threshold to operate the vehicle 145. The selected replacement operation can map to the identified operation and uses less computing resources relative to the identified operation.

The threshold can be based on the service, job, or purpose that the machine learning model 115 performs for the vehicle 145. For example, the model 115 can recognize or detect different types of objects in a driving environment of the vehicle 145. The model 115 may have a high accuracy level for performing the object classifications. A segmentation model 115 that classifies road versus other surfaces or structures (surfaces or structures that are not a road) may have a threshold even higher than the object classification model 115. A security model 115 that distinguishes between entities (e.g., dogs versus people) around the vehicle 145 when the vehicle 145 is locked may have a lower accuracy threshold so that an alarm is raised more easily.

The replacement selector 125 can receive, store, or generate a threshold or tolerance level for accuracy of the machine learning model 115 to be deployed to the vehicle 145. The replacement selector 125 can generate the threshold to use in identifying replacement operations 130 based on a type of the vehicle 145, a workload of the machine learning model 115, the application that uses the machine learning model 115. For example, self-driving or ADAS features may have a first threshold while route suggestion applications or comfort features can have a second threshold lower than the first threshold.

For example, the replacement selector 125 can iteratively test each replacement operation 130 in the machine learning model 115 and generate an accuracy level or score for each replacement operation 130. For example, the replacement selector 125 can include or receive a data set to test the machine learning model 115 with. The data set may be a validation dataset withheld from training the machine learning model 115. The machine learning model 115 can be fully trained before the operation identifier 120 identifies the operation to be replaced and before the replacement selector 125 selects a replacement operation 130. The replacement selector 125 can iteratively replace the identified operation with each replacement operation 130, execute the machine learning model 115 with the validation data set, and generate an accuracy for each replacement operation 130. The accuracy can be a percentage (e.g., the number of correct predictions made versus a total number of predictions attempted). In addition to, or instead of accuracy, the replacement selector 125 can generate a precision value, a recall value, an F-score, a confusion matrix, or a receiver operating curve (ROC) for each replacement operation 130.

The replacement selector 125 can generate the accuracy level for each of the replacement operations 130 by measuring, determining, or identifying values generated at a point within the machine learning model 115. For example, the replacement selector 125 can select a point or output of a particular operation within the machine learning model 115. The replacement selector 125 can replace the identified operation with the replacement operation 130 and determine the values generated by the machine learning model 115 at the point within the model. The replacement selector 125 can compare the determined values to values generated by the original identified operation. The replacement selector 125 can determine the values at the point for each operation and use the values to generate the accuracy for each operation.

The replacement selector 125 can select the point to be an output of an operation within the machine learning model 115. For example, the replacement selector 125 can select an output of an operation within the machine learning model 115 that receives the input of the identified operation. The selected operation for measuring the accuracy can execute immediately after the identified operation, or after a particular number of operations after the operation identified for replacement. The replacement selector 125 can identify the point to measure accuracy within the machine learning model 115 with a graph representing the machine learning model 115. The replacement selector 125 can identify a first node representing the identified operation and identifying a second node representing another operation that operates based on the output of the identified operation and is separated from the first node by a number of nodes or edges less than a threshold. The replacement selector 125 can select the second node responsive to identifying that the second node is separated by a number of nodes or edges less than a threshold and determining that the operation represented by the second node receives an input which is, or is based on, the output of the identified operation. The replacement selector 125 can use the output of the operation represented by the second node to determine the accuracy for each of the replacement operations 130 when the replacement operations 130 are inserted into the machine learning model 115 and the machine learning model 115 is executed.

The replacement selector 125 can determine or identify a level of computing resources used to execute each replacement operation 130 in the machine learning model 115. For example, the replacement selector 125 can determine a lookup table size, a number of multiplication coefficients used to execute a number of multiplication operations for the replacement operation 130, a length of time the replacement operation 130 takes to execute, a number of processing cycles used to complete the operation, an amount of memory required to store or execute the operation. The replacement selector 125 can generate discrete metrics or scores or generate a composite score combining multiple resource consumption metrics.

The replacement selector 125 can select one replacement operation 130 from a set of replacement operations 130 based on an accuracy of each replacement operation 130 within the machine learning model 115 and a level of computing resources consumed by each replacement operation 130. For example, the replacement selector 125 can select a replacement operation 130 that consumes the least amount of computing resources but has an accuracy greater than a threshold. The threshold can be set based on a level of accuracy used to operate the vehicle 145.

The replacement selector 125 can optimize an objective function, a cost function, or a loss function to select a replacement operation 130. For example, after testing each replacement operation 130 in the machine learning model 115, the replacement selector 125 can optimize the objective function using the accuracy and resource consumption of each replacement operation 130. The optimization can be based on constraints used to search a space of replacement operations 130 for one replacement operation 130 to use in the machine learning model 115. The constraints may an inequality or equality constraint. For example, a constraint may be an inequality constraint to identify a replacement operation 130 with an accuracy greater than a threshold. The constraints can include an inequality constraint to identify a replacement operation 130 with a resource consumption less than a threshold. The replacement operation 130 can optimize the objective function to minimize resource consumption, maximize accuracy, or balance resource consumption and accuracy. For example, the replacement operation 130 can optimize an objective function with accuracy and resource consumption as decision variables. The optimization of the objective function can be performed with at least one optimization algorithm, such as the primal simplex algorithm, criss-cross algorithm, interior point algorithm.

The replacement selector 125 can replace the identified operation in the machine learning model 115 with the selected replacement operation 130. The replacement selector 125 can generate an updated machine learning model 135. The replacement selector 125 can delete the identified operation and insert, save, or add the selected replacement operation 130 to the machine learning model 115 to generate the updated machine learning model 135. The updated machine learning model 135 may be otherwise identical to the machine learning model 115 except for the replacement operation 130 inserted into the machine learning model 115. The updated machine learning model 135 can generate an output different than the output that the machine learning model 115 would generate. For example, the updated machine learning model 135 can output different values than the machine learning model 115 would output given a particular input.

The machine learning model 115 can include multiple models or sub-models. The operation identifier 120 can identify operations in each of the models of the machine learning model 115 and the replacement selector 125 can select replacement operations 130 for each identified operation. The identification and replacement can be performed iteratively. For example, the operation identifier 120 can identify a first operation in a first model and then the replacement selector 125 can select a replacement operation 130 for the first operation. Then, the operation identifier can identify a second operation in a second model and then the replacement selector 125 can select a replacement operation 130 for the second operation. The operation identifier 120 and the replacement selector 125 can iteratively analyze each sub-model within the machine learning model to identify and replace the operations of the sub-models.

The data processing system 105 can include a deployer 140. The deployer 140 can be a piece of software, a script, a function, an executable, instructions, or code. The deployer 140 can receive the updated machine learning model 135 from the replacement selector 125. The deployer 140 can deploy the updated machine learning model 135 to the vehicle 145. The vehicle 145 can include a computing system 150. The deployer 140 can deploy the updated machine learning model 135 to the computing system 150 of the vehicle 145. For example, the deployer 140 can transmit, send, deliver, or communicate the updated machine learning model 135 over one or more networks, connections, or programming interfaces to store the updated machine learning model 135 on the computing system 150. The computing system 150 can include one or more components or functionality of the data processing system 105.

The computing system 150 of the vehicle 145 can store the updated machine learning model 135. The computing system 150 of the vehicle 145 can include a model executor 160. The model executor 160 can be a piece of software, a script, a function, an executable, instructions, or code. The model executor 160 can be a neural network or machine learning engine that executes machine learning models. The model executor 160 can be a GPU, CPU, or piece of hardware that executes machine learning models 115.

The model executor 160 can execute the updated machine learning model 135 to operate a drive system 155 of the vehicle 145. The model executor 160 can collect data from sensors or input devices 165 of the vehicle, e.g., radar systems, LIDAR systems, cameras, distance sensors, color sensors, vibration sensors, a steering wheel, an accelerator, a brake, or data from other sensors or data sources of the vehicle 145. The model executor 160 can execute the updated machine learning model 135 with the sensor data received from sensors 165 as an input and generate an output. The output can be a decision to operate the vehicle 145. The output can be information used by another system, application, or model to operate the vehicle 145. For example, the output of the updated machine learning model 135 can be a point map that fuses data of multiple data sources that another system, application, or model uses to drive the vehicle 145. For example, the output can indicate that the vehicle 145 is straying out of a lane. The output can indicate that the vehicle 145 is approaching an object and is to brake. The output can indicate that the vehicle 145 is to turn to follow a curve in a road. The output can indicate to adjust a speed (e.g., increase or decrease the speed) of a vehicle to maintain a following distance from another vehicle.

Based on the output of the updated machine learning model 135, the computing system 150 can transmit, send, deliver, or communicate commands to a drive system 155 of the vehicle 145. The drive system 155 can include motors, high voltage distribution boxes (HVDBs), gears, or brakes. The drive system 155 can operate the motors to drive the vehicle 145 forward, backward, accelerate, decelerate, turn, or brake. The drive system 155 can operate the vehicle 145 to transport, translate, or move. For example, based on an output of the updated machine learning model 135, the drive system 155 can cause power to be delivered to the vehicle motors at different voltage levels, duty cycles, or frequency of an alternative current (AC) voltage. The output can indicate that a vehicle is straying out of a lane to the left or right, and the drive system 155 can operate the drive system 155 to center the vehicle 145 within the lane. The output can indicate that the vehicle 145 is approaching an object and the drive system 155 can operate to brake the vehicle 145 to avoid contacting the object. The output can indicate a distance between the vehicle 145 and another vehicle in front of the vehicle 145. The drive system 155 can operate based on the output to maintain a following distance between the vehicle 145 and the other vehicle by increasing or decreasing a speed of the vehicle 145.

The model executor 160 can store multiple versions of the updated machine learning model 135. For example, the replacement selector 125 can generate multiple versions of the updated machine learning model 135 with the machine learning model 115 with various levels of accuracy or computing resources consumption. For example, the replacement selector 125 can generate a first updated machine learning model 135 with a first accuracy threshold. The first updated machine learning model 135 can consume a first level of computing resources.

The replacement selector 125 can generate a second updated machine learning model 135 with a second accuracy threshold. The first updated machine learning model 135 can consume a second level of computing resources. The second accuracy threshold can be greater than the first threshold. Furthermore, the second level of computing resources can be greater than the first level of computing resources. Both updated machine learning models 135 can be deployed to the model executor 160. The model executor 160 can receive an input and trigger a selection and execution of the first updated machine learning model 135 or the second updated machine learning model 135. For example, the input might be a driving mode of the vehicle 145, a type of the road that the vehicle 145 is driving on (e.g., expressway, city street, country road, driveway), or a speed at which the vehicle 145 is driving. For example, when the vehicle 145 is driving on the expressway or at a first speed, the model executor 160 can retrieve and execute an updated machine learning model 135 calibrated to be accurate with depth measurements up to fifty meters to operate the vehicle 145. When the vehicle 145 is driving on a driveway or at a second speed lower than the first speed, the model executor 160 can retrieve and execute an updated machine learning model 135 calibrated to be accurate with depth measurements up to five meters to operate the vehicle 145.

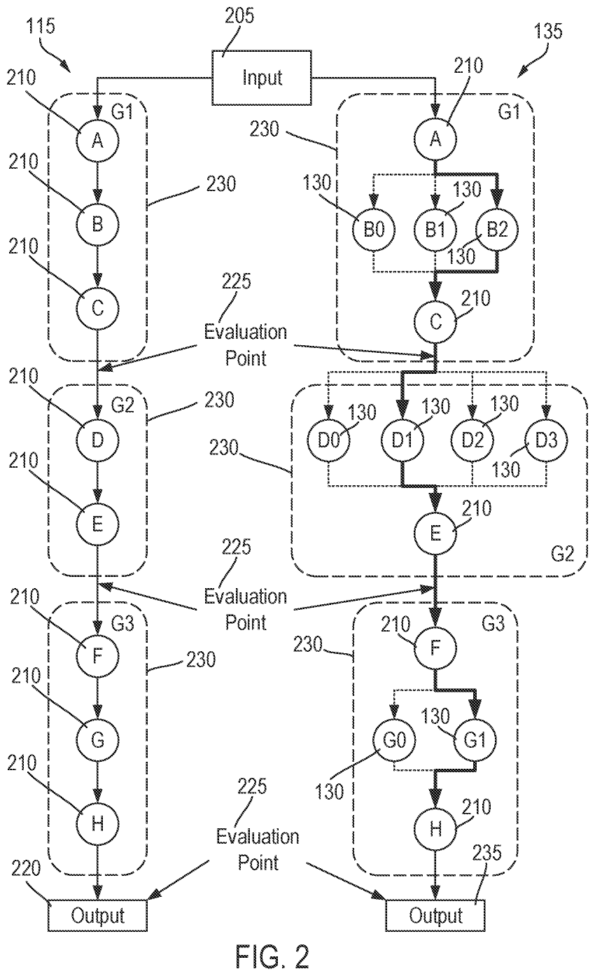

FIG. 2, among others, illustrates an example machine learning model 115 that includes operations 210 replaced by operations 130 that consume less computing resources. The machine learning model 115 can be represented as a graph in FIG. 2, where every operation 210 is represented by nodes and edges link the nodes to represent the flow of information through the machine learning model 115. The machine learning model 115 includes sub-models 230 represented as sub-graphs G1, G2, and G3 within the larger graph representing the machine learning model 115. The machine learning model 115 and the updated machine learning model 135 can each be trained to execute based on at least one input 205. The input 205 can be data collected, measured, or generated by the sensor 165. The input 205 can be an image taken by a camera of a surrounding of the vehicle 145. The input 205 can be a depth value of a depth sensor 165 measured by the vehicle 145 between the vehicle and an object, such as another vehicle, a tree, a rock, or a wall. The input 205 can be a radar data captured by a radar system of the vehicle 145. The input 205 can be LIDAR data captured by a LIDAR system of the vehicle 145.

The operation identifier 120 can identify operations in the machine learning model 115, or across the sub-models of the machine learning model 115, that consume an amount of processing resources greater than a threshold (e.g., are non-linear operations). For example, in FIG. 2, the operation identifier 120 can identify an operation B, and operation D, and an operation G that consume an amount of processing resources greater than a threshold (e.g., are non-linear operations). For each of the identified operations, the replacement selector 125 can search the replacement operations 130 to identify operations 130 that can approximate or map to the identified operations. For example, the replacement selector 125 can identify a set of operations 130 for each identified operation 210. For example, the replacement selector 125 can identify three replacement operations B0, B1, and B2 that can approximate operation B. The replacement selector 125 can identify four replacement operations D0, D1, D2, and D3 that can approximate the operation D. The replacement selector 125 can identify two replacement operations G0 and G1 that can approximate the operation G.

The replacement selector 125 can identify at least one evaluation point 225 within the model 115 to measure the accuracy of each replacement operation 130 at. The replacement selector 125 can identify a first evaluation point 225 for evaluating the performance of a first operation, the replacement selector 125 can identify a second evaluation point 225 for evaluating the performance of a second operation, the replacement selector 125 can identify a third point 225 for evaluating the performance of a third operation. For example, for measuring the accuracy of the replacement operations 130 for the operation B, the replacement selector 125 can select an evaluation point 225 to be an output of the model 230 that the operation B is included within. For example, the replacement selector 125 can select the output of the operation C as the evaluation point 225 for evaluating the performance of the operation B. Similarly, the replacement selector 125 can select the output of the operation E as an evaluation point 225 to evaluate the performance of the replacement operations 130 for the operation D. Furthermore, the replacement selector 125 can select the output 220 as the evaluation point 225 for measuring the performance of each of the replacement operations 130 for the operation G.

The replacement selector 125 can use a dataset, e.g., a validation dataset used for validating the training of the model 115, to identify the accuracy of the replacement operations 130. The replacement selector 125 can measure a value or values at the evaluation point 225 which may be the output of operation C when the operation B is used in the model 115 and the model 115 is executed on the dataset. When measuring the values for the operation B, none of the other operations of the model 115 may be replaced with replacement operations 130. The replacement selector 125 can iteratively replace the operation B with each of the operations B0, B1, and B2. The replacement selector 125 can execute the model 115 with the dataset for each replacement operation 130 and measure values at the evaluation point 225 (e.g., the output of operation C) when each replacement operation 130 is used in the model 115. The replacement selector 125 can use the values measured for the original operation B and each replacement operation B0, B1, and B2 to generate an accuracy or performance level for each operation B0, B1, and B2. For example, to generate an accuracy of the operation B0, the replacement selector 125 can compare the values at the output of operation C generated by the model 115 when the model 115 is executed on the dataset when operation B is used in the model 115 to the values generated by the model 115 at the output of operation C when the model 115 is executed on the dataset when operation B0 is used in the model 115.

The replacement selector 125 can identify a level of computing resources consumed by each replacement operation B0, B1, and B2. The replacement selector 125 can select one of the replacement operations B0, B1, and B2 to replace the operation B based on the accuracy level of each of the replacement operations B0, B1, and B2 and the level of computing resources consumed by each replacement operation B0, B1, and B2. The replacement selector 125 can select one replacement operation 130 that has an accuracy level greater than a threshold and consumes the least amount of computing resources compared to the other replacement operations 130. For example, in FIG. 2, the replacement selector 125 can select the operation B2 to replace the operation B.

The replacement selector 125 can repeat the process of executing the model 115 with the original operations 210 and each of the replacement operations 130 and measuring values at the evaluation point 225. For example, once the operation B2 is identified as a replacement for operation B, the replacement selector 125 can identify one of operations D0, D1, D2, and D3 to replace the operation D. The replacement selector 125 can execute the model 115 based on the dataset with operation D and measure the values at the evaluation point 225 (e.g., the output of operation E). The replacement selector 125 can iteratively replace the operation D with the operations D0, D1, D2, and D3, execute the model 115 based on the dataset, and measure the values at the output of operation E. The replacement selector 125 can compare the values generated at the evaluation point 225 when the model 115 is executed with the operation D against the values generated at the evaluation point 225 when the model 115 is executed with the operations D0, D1, D2, and D3 respectively. When the model 115 is executed to identify a replacement for the operation D, the model can be executed with the replacement operation selected to replace operation B. i.e., operation B2. The replacement selector 125 can repeat the process of executing the model 115 with the original operations 210 and each of the replacement operations 130 and measuring values at the evaluation points 225. The updated machine learning model 135 can generate an output 235. For a given input, the output 235 generated by the updated machine learning model 135 can be different than the output 220 generated by the machine learning model 115.

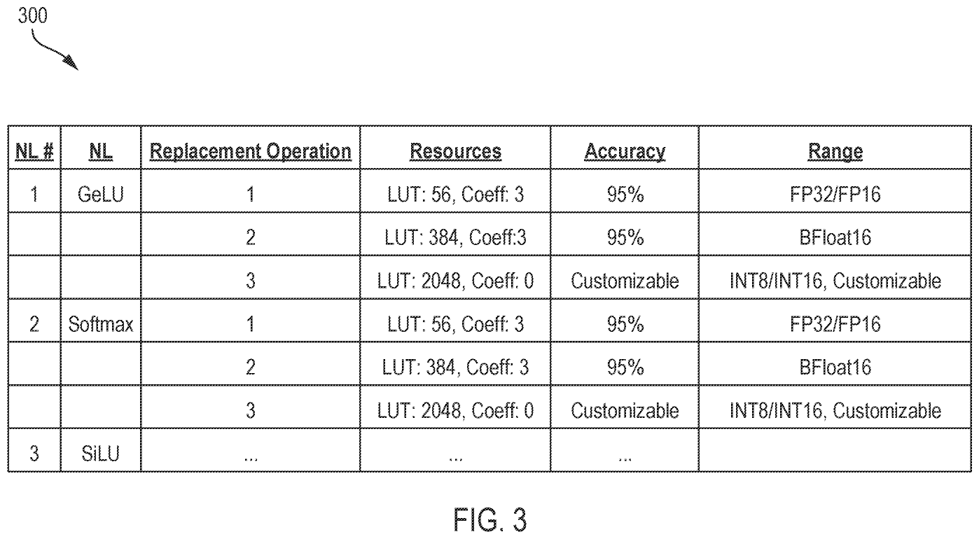

FIG. 3, among others, depicts an example table 300 indicating resource consumption and accuracy of linear operations 130 that approximate non-linear operations 210 of the machine learning model 115. The table 300 can be a data structure generated by the data processing system 105 to update the machine learning model 115. For example, the operation identifier 120 and the replacement selector 125 can build the table 300 and use the table 300 to update the machine learning model 135. The data processing system 105 can generate a graphical representation of the table 300 and present the graphical representation to a user in a user interface on a user device.

The table 300 can include a first column identifying three different non-linear operations 210, a first operation, a second operation, and a third operation. While table 300 illustrates three non-linear operations 210 identified for replacement in the model 115, any number of operations 210 for replacement can be included in the table 300. A second column of the table 300 can identify a type of the three non-linear operations 210, GeLU, Softmax, and SiLU. The table 300 can include indices of different approximation methods. For the GeLU operation 210, there may be three approximation operations 130 identified that can approximate the GeLU operation 210. For the Softmax operation 210, there may be three approximation operations 130 identified that can approximate the Softmax operation 210.

The table 300 can include a column indicating resources consumed by the replacement operations 130. Each row in the column can indicate a lookup table (LUT) size and a number of multiplication coefficients (coeffs). The table 300 can include an accuracy column. The accuracy column can indicate an accuracy level of the model 115 executed with each replacement operation 130 compared to the model 115 executed with the operation 210 identified for replacement. The table 300 can include a range column. The range column can indicate the data types that are output by each of the replacement operations 130. For example, a first replacement operation 130 may be a 32 bit floating point (FP32) output or a 16 bit floating point (FP16) output. A second replacement operations 130 might have a brain 16 bit floating point (BFloat16) output. A third replacement operation 130 might have a customizable output. The output of the third replacement operation 130 can be either a signed 8-bit integer (INT8) or a signed 16-bit integer (INT16).

The table 300 can indicate replacement operations 130 for a Softmax operation 210. The replacement operations 130 can include a 32-bit floating point (FP32) output or a 16-bit floating point (FP16) output. Another replacement operation 130 can include a 16-bit brain floating point (BFloat16) output. A third replacement operation 130 might have a customizable output. The output of the third replacement operation 130 can be either a signed 8-bit integer (INT8) and a signed 16-bit integer (INT16).

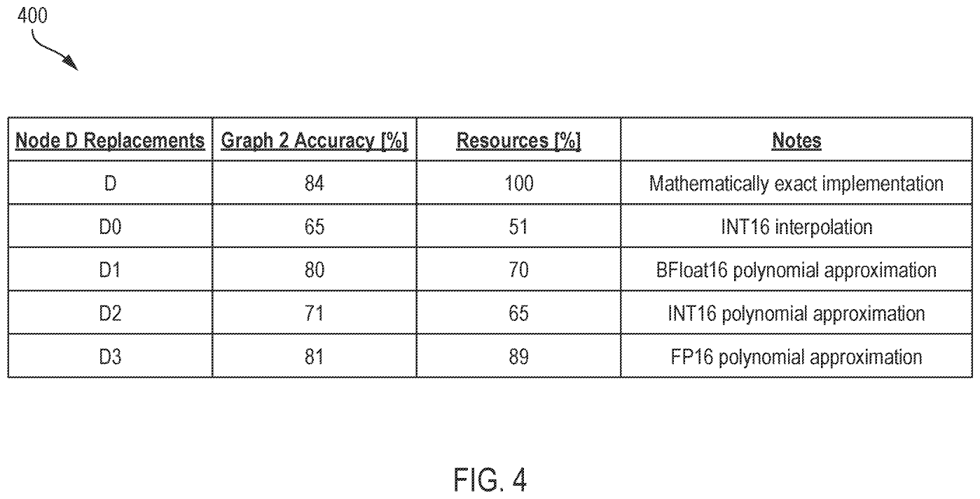

FIG. 4, among others, depicts an example table 400 indicating accuracy and resource consumption for multiple replacement operations 130. The table 400 can be a data structure generated by the data processing system 105 to update the machine learning model 115. For example, the operation identifier 120 and the replacement selector 125 can build the table 400 and use the table 400 to update the machine learning model 135. The data processing system 105 can generate a graphical representation of the table 400 and present the graphical representation to a user in a user interface on a user device.

The table 400 can include a column of replacement operations 130 for an identified operation of a sub-model, e.g., node D for the sub-model represented by sub-graph G2. For example, the replacement operations 130 can be D0, D1, D2, and D3. The table 400 can include columns for accuracy and resource consumption. The accuracy of each replacement operation 130 can be relative to the accuracy of the operation represented by node D in the machine learning model 115 or to truth values.

The replacement selector 125 can execute the machine learning model 115 with the operation D and measure values at the evaluation point 225 at the output of the operation E in the machine learning model 115. The replacement selector 125 can use the measured values to determine an accuracy level of the operation D. The accuracy of the level of the operation D may be 84% accuracy. Because the resource consumption is measured relative to operation D, the resource consumption level of the node D can be 100%.

The replacement selector 125 can identify a set of replacement operations 130 from a library, database, or data repository. The replacement selector 125 can identify an operation D0, an operation D1, an operation D2, and an operation D3 that can replace the identified operation D. The replacement selector 125 can execute the machine learning model 115 with each of the operations D0, D1, D2, and D3. The replacement selector 125 can measure values at the evaluation point 225 (at the output of operation E) for each execution of the machine learning model 115 with each of the operations D0, D1, D2, and D3. The replacement selector 125 can determine an accuracy level for each operation based on the measured values. For example, the values generated at the output of operation E when the model 115 is executed with operation D0 can be used to generate an accuracy level for the operation D0. The values generated at the output of operation E when the model 115 is executed with operation D1 can be used to generate an accuracy level for the operation D1. The values generated at the output of operation E when the model 115 is executed with operation D2 can be used to generate an accuracy level for the operation D2. The values generated at the output of operation E when the model 115 is executed with operation D3 can be used to generate an accuracy level for the operation D3.

The accuracy level of the operation D0 can be 65%. The accuracy level of the operation D1 can be 80%. The accuracy level of the operation D2 can be 71%. The accuracy level of the operation D3 can be 81%. The table 300 can include a column of notes for each operation. Because the replacement selector 125 can determine accuracy and resources of each replacement operation 130, the replacement selector 125 can balance accuracy degradation and resource trade-offs to enable the replacement selector 125 to increase the performance of the machine learning model 115 when deployed to the vehicle 145.

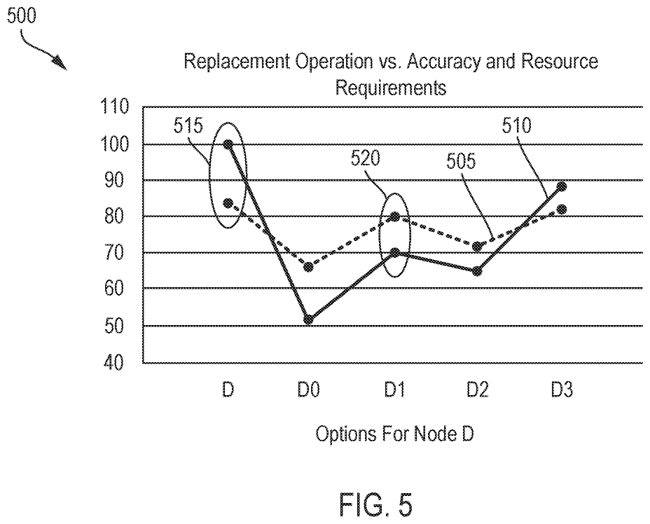

FIG. 5, among others, depicts an example chart 500 plotting accuracy and resource consumption for multiple operations 130 that approximate a particular operation 210 of the machine learning model 115. The chart 500 can be a data structure generated by the data processing system 105 to update the machine learning model 115. For example, the operation identifier 120 and the replacement selector 125 can build the chart 500 and use the chart 500 to update the machine learning model 135. The data processing system 105 can generate a graphical representation of the chart 500 and present the graphical representation to a user in a user interface on a user device.

The chart 500 includes a trend 505 and a trend 510. The trend 505 can be a trend of accuracy for the replacement operations D0, D1, D2, and D3. The trend 510 can be a trend of resource consumption for replacement operations D0, D1, D2, and D3. The values plotted in the chart 500 can be the accuracy and resource consumption levels of table 400.

Element 515 in chart 500 can identify a most mathematically exact operation, D. The chart 500 can include an element 520 in the chart 500 identifying an operation D1 selected to replace the operation D in the machine learning model 115. The replacement selector 125 can identify the operation D1 as providing an accuracy level greater than a threshold but a resource consumption level less than a threshold. The replacement selector 125 can identify an operation D1 providing an accuracy level greater than a threshold but a smallest resource consumption level of all of the replacement operations 130 that have an accuracy level above the threshold.

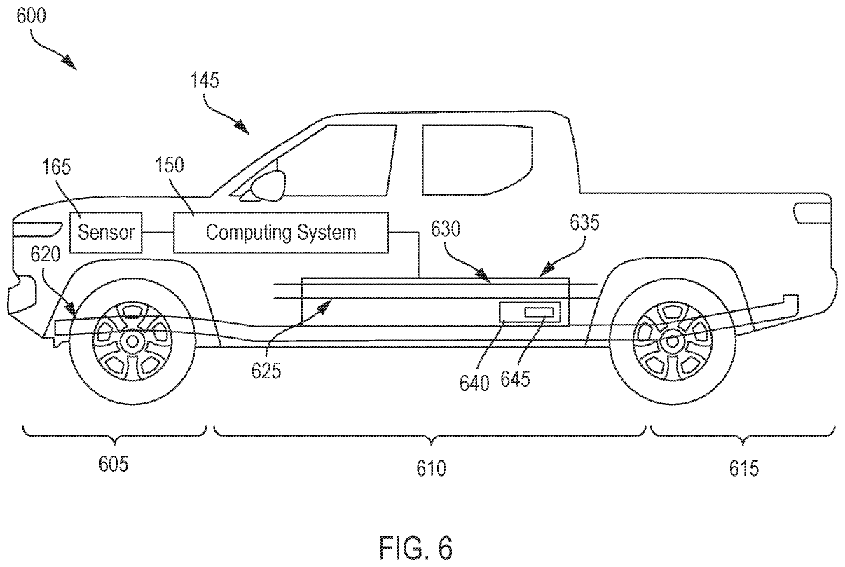

FIG. 6 depicts an example cross-sectional view 600 of an electric vehicle 145 installed with at least one battery pack 635. Electric vehicles 145 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 635 can also be used as an energy storage system to power a building, such as a residential home or commercial building. Electric vehicles 145 can be fully electric or partially electric (e.g., plug-in hybrid) and further, electric vehicles 145 can be fully autonomous, partially autonomous, or unmanned. Electric vehicles 145 can also be human operated or non-autonomous. Electric vehicles 145 such as electric trucks or automobiles can include on-board battery packs 635, batteries 645 or battery modules 640, or battery cells 645 to power the electric vehicles. The electric vehicle 145 can include a chassis 620 (e.g., a frame, internal frame, or support structure). The chassis 620 can support various components of the electric vehicle 145. The chassis 620 can span a front portion 605 (e.g., a hood or bonnet portion), a body portion 610, and a rear portion 615 (e.g., a trunk, payload, or boot portion) of the electric vehicle 145. The battery pack 635 can be installed or placed within the electric vehicle 145. For example, the battery pack 635 can be installed on the chassis 620 of the electric vehicle 145 within one or more of the front portion 605, the body portion 610, or the rear portion 615. The battery pack 635 can include or connect with at least one busbar, e.g., a current collector element. For example, the first busbar 630 and the second busbar 625 can include electrically conductive material to connect or otherwise electrically couple the battery 640, the battery modules 640, or the battery cells 645 with other electrical components of the electric vehicle 145 to provide electrical power to various systems or components of the electric vehicle 145.

In FIG. 6, the vehicle 145 can include a computing system 150. The computing system 150 can execute the updated machine learning model 135 based on sensor measurements of sensors 165 of the vehicle 145. For example, the computing system 150 can receive data from sensors or input devices 165 of the vehicle, e.g., radar systems, light detection and ranging (LIDAR) systems, cameras, distance sensors, color sensors, vibration sensors, or data from other sensors or data sources of the vehicle 145. The computing system 150 can execute the updated machine learning model 135 with the sensor data as an input and generate an output. The computing system 150 can use the output to operate the vehicle 145. For example, the computing system 150 can power on or power off the vehicle 145. The computing system 150 can cause the vehicle 145 to drive forwards or reverse. The computing system 150 can control a speed of the vehicle 145, an acceleration of the vehicle 145, a turn of the vehicle 145. The computing system 150 of the vehicle 145 can use the output 235 of the updated machine learning model 135 to control the drive system 155 of the vehicle.

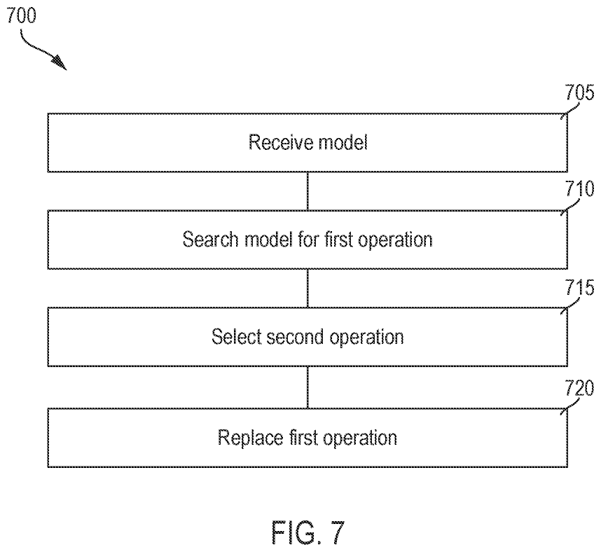

FIG. 7, among others, depicts an example method 700 of reducing the computing resource consumption of the machine learning model 115. The method 700 can include a step 705 of receiving a model. The method 700 can include a step 710 of searching a model for a first operation. The method 700 can include a step 715 of selecting a second operation. The method 700 can include a step 720 of replacing a first operation. At least a portion of the method 700 can be performed by the data processing system 105. At least a portion of the method 700 can be performed by the operation identifier 120, the replacement selector 125, or the deployer 140 of the data processing system 105. At least a portion of the method 700 can be performed by the computing system 150. At least a portion of the method 700 can be performed by the model executor 160. At least a portion of the method 700 can be performed by the sensor 165. At least a portion of the method 700 can be performed by the drive system 155.

In step 705, the method 700 can include receiving, the data processing system 105, a model. The data processing system 105 can receive the machine learning model 115 from a model source 110. The data processing system 105 can retrieve or request the machine learning model 115 from the model source 110. The data processing system 105 can receive a fully or partially trained model 115. For example, the model source 110 can be a data repository of machine learning models 115 that have been fully designed or fully trained. The operation identifier 120 can receive the machine learning model 115 from a component or data source within the data processing system 105, e.g., the model source 110. The operation identifier 120 can receive the machine learning model 115 from a component external to the data processing system 105.

In step 710, the method 700 can include searching, by the data processing system 105, a model for a first operation. For example, the operation identifier 120 can search the machine learning model 115 to identify a first operation 210 to replace with an approximation. For example, the operation identifier 120 can search the operations 210 of the machine learning model 115 to identify operations 210 that are non-linear operations. For example, the operation identifier 120 can search for names, libraries, tags, indicators, or other data that indicates that a particular operation 210 is a non-linear operation. The machine learning model 115 can generate a value indicating a resource consumption of each operation 210 in the machine learning model 115. For example, the operation identifier 120 can identify at least one first operation 210 that consumes a level of resources greater than a threshold. The identified first operations 210 can be identified as operations to be replaced with a replacement operation 130.

In step 715, the method 700 can include selecting, by the data processing system 105, a second operation. The replacement selector 125 can select a second operation 130 to replace the first operation 210. The replacement selector 125 can select a replacement operation 130 to approximate and replace the identified operation in step 710. For example, the replacement selector 125 can search replacement operations 130 to identify at least one replacement operation 130 that can approximate the first operation identified in step 710. For example, the replacement selector 125 can search a library of replacement operations 130 with an identifier for the identified operation to identify a set or group of replacement operations 130 that can approximate or map to the identified operation 210.

The replacement selector 125 can identify an evaluation point 225 within the machine learning model 115 to evaluate the performance of each of the replacement operations 130 identified that can approximate the first operation 210. The replacement selector 125 can select a point within the machine learning model 115 to measure values at. The replacement selector 125 can iteratively replace the first operation 210 with each identified replacement operation 130 and execute the machine learning model 115 with the replacement operations 130. The replacement selector 125 can measure the values at the evaluation point 225 for each replacement operation 130. The replacement selector 125 can generate an accuracy level for each replacement operation 130.

The replacement selector 125 can identify the evaluation point 225 by identifying an output of an operation that uses the output of the first operation 210 as an input to the operation. The replacement selector 125 can identify a next or subsequent operation in the machine learning model 115 that executes based on the output of the first operation 210. For example, the replacement selector 125 can search a graph representation of the machine learning model 115 and identify a node representing an operation that uses the output of the first operation 210 as an input by identifying that the node is separated from a node representing the identified operation 210 by a number of nodes or edges less than a threshold, e.g., identify a least number of nodes or edges.

In step 720, the method 700 can include replacing, by the data processing system 105, the first operation. The data processing system 105 can delete the first operation and save the second operation in place of the first operation. The data processing system 105 can connect the input into the first operation 210 to the second operation 130. The data processing system 105 can identify that an output of the first operation 210 was used as an input into a third operation. The data processing system 105 can connect the output of the second operation 130 to the input of the third operation responsive to the identification.

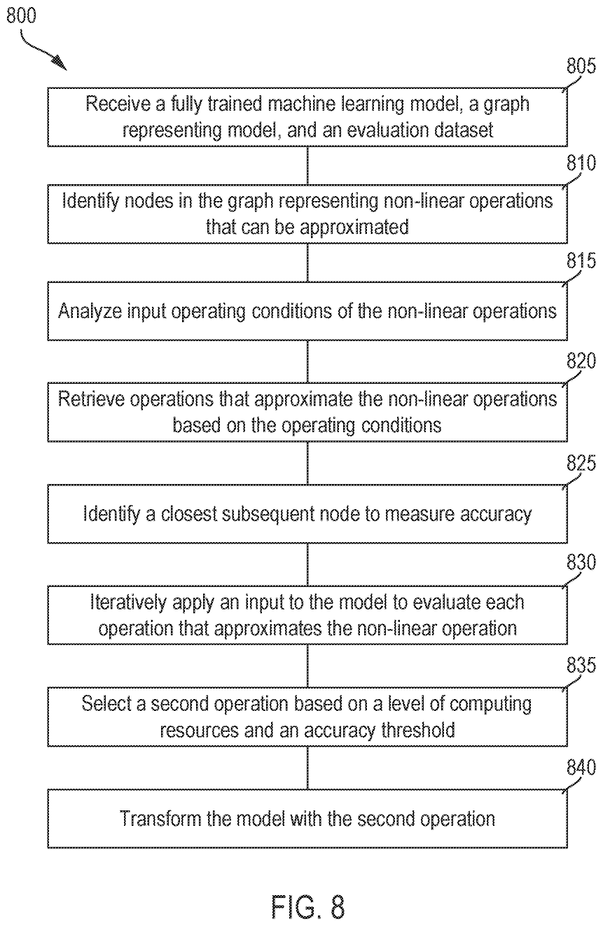

FIG. 8, among others, depicts another example method 800 of reducing the computing resource consumption of the machine learning model 115. The method 800 can include a step 805 of receiving a fully trained machine learning model, a graph representing the model, and an evaluation dataset. The method 800 can include a step 810 of identifying nodes in the graph representing non-linear operations that can be approximated. The method 800 can include a step 815 of analyzing input operating conditions of the non-linear operations. The method 800 can include a step 820 of retrieving operations that approximate the non-linear operations based on the operating conditions. The method 800 can include a step 825 of identifying a closest subsequent node to measure accuracy. The method 800 can include a step 830 of iteratively apply an input to the model to evaluate each operation that approximates the non-linear operation. The method 800 can include a step 835 of selecting a second operation based on a level of computing resources and an accuracy threshold. The method 800 can include a step 840 of transforming the model with the second operation.

At least a portion of the method 800 can be performed by the data processing system 105. At least a portion of the method 800 can be performed by the operation identifier 120, the replacement selector 125, or the deployer 140 of the data processing system 105. At least a portion of the method 800 can be performed by the computing system 150. At least a portion of the method 800 can be performed by the model executor 160. At least a portion of the method 800 can be performed by the sensor 165. At least a portion of the method 800 can be performed by the drive system 155.

In step 805, the method 800 can include receiving, by the data processing system 105, a fully trained machine learning model, a graph representing the model, and an evaluation dataset. The operation identifier 120 can receive a fully or partially trained model. For example, the operation identifier 120 can be trained with a training dataset before the operation identifier 120 receives the machine learning model 115. The operation identifier 120 can receive a graph representing the machine learning model 115. The graph can be a data structure that is part of, or separate from, the machine learning model 115. The graph can include nodes representing the operations or layers of the machine learning model 115. The graph can include edges between the nodes representing connections between inputs and outputs of the operations represented by the node. For example, an edge between a first node representing a first operation and a second node representing a second operation indicates that the output of the first operation is used as an input to the second operation.

In step 810, the method 800 can include identifying, by the data processing system 105, nodes in the graph representing non-linear operations that can be approximated. For example, the operation identifier 120 can search the graph to identify a node of the graph that represents an operation that is a non-linear operation. The operation identifier 120 can search the graph and select a node tagged, labeled, or identified as representing a non-linear operation.

In step 815, the method 800 can include analyzing, by the data processing system 105, input operating conditions of the non-linear operations. The operating conditions can be the type of non-linear operation, e.g., GeLU, Softmax, or SiLU. In step 820, the method 800 can include retrieving, by the data processing system 105, operations that approximate the non-linear operations based on the operating conditions. For example, the replacement selector 125 can identify a set or group of replacement operations 130 that can approximate the operations represented by non-linear nodes. The search can be based on the name or type of the non-linear operation. For example, the replacement selector 125 can identify that a first set of linear operations can approximate a GeLU operation. The replacement selector 125 can identify that a second set of linear operations can approximate a Softmax operation. The replacement selector 125 can identify that a first set of linear operations can approximate a SiLU operation.

In step 825, the method 800 can include identifying, by the data processing system 105, a closest subsequent node to measure accuracy. For example, for each non-linear node that the operation identifier 120 identifies, the replacement selector 125 can select an evaluation point 225. The evaluation points 225 can be the output of a closest subsequent node to the node representing the identified operation. For example, the replacement selector 125 can search the graph to identify a node in the graph the appears subsequent to the identified node. For example, the replacement selector 125 can execute either directly or indirectly based on the output of the identified node. The replacement selector 125 can identify a node to measure accuracy at by determining that a number of nodes or edges between the node identified for replacement and at least one other node to measure accuracy at. The replacement selector 125 can identify a node to measure accuracy at by identifying a node separated from the node identified for replacement that is separated by a least number of nodes or a least number of edges. The replacement selector 125 may only search nodes that are not being replaced in the machine learning model 115, e.g., nodes representing operations that consume processing resource less than a threshold or nodes that represent operations that are linear.

The replacement selector 125 can select the final output 220 of the machine learning model 115 as the evaluation point 225 to evaluate the performance of one or multiple replacement operations 130 that replace the non-linear operations 210. Measuring the output 220 for updating the machine learning model 115 may result in a highly accurate updated machine learning model 135. However, using the output 220 as the evaluation point 225 can result in a long duration of time used to update the machine learning model 115 or a large amount of computing resources used to update the machine learning model 115. By selecting evaluation points 225 within the machine learning model 115 close to each identified non-linear operation, testing and replacing each non-linear operation individually in a piecewise manner can be performed in a short period of time, with a lower amount of power consumption, or with a lower amount of processing resources.

In step 830, the method 800 can include iteratively applying, by the data processing system 105, an input to the model to evaluate each operation that approximates the non-linear operation. For example, the replacement selector 125 can receive a dataset. The dataset can be the evaluation dataset received in step 805. The dataset can be a training dataset, a validation dataset, or a testing dataset. The replacement selector 125 can iteratively replace the identified non-linear operation with each of the identified linear operations, execute the machine learning model 115 with each of the non-linear operations, and measure the values at the evaluation point 225 within the machine learning model 115. The machine learning model 115 can be executed with the evaluation dataset as the input 205 to the machine learning model 115. The evaluation point 225 can be the output of individual sub-models within the machine learning model 115 or the output 220 of the machine learning model 115.

In step 835, the method 800 can include selecting, by the data processing system 105, a second operation based on a level of computing resources and an accuracy threshold. For example, the replacement selector 125 can select a replacement operation 130 from a set of replacement operations 130 that can approximate the first operation based on the accuracy level of each replacement operation 130, a level of computing resources consumed by each replacement operation 130, and an accuracy threshold. The replacement selector 125 can select a replacement operation 130 from the set of replacement operations that consumes a least amount of processing resources but has an accuracy level greater than the accuracy threshold. The replacement selector 125 can select a replacement operation 130 with a tolerable level of accuracy loss.

In step 840, the method 800 can include transforming, by the data processing system 105, the model with the second operation. For example, the replacement selector 125 can generate the updated machine learning model 135 by replacing the first non-linear operation 210 with the second replacement operation 130. The method of transforming the machine learning model 135 can be iterative. For example, the operation identifier 120 can identify a first non-linear operation 210 and a second non-linear operation 210. The replacement selector 125 can identify a set of replacement operations 130 that can approximate the first non-linear operation. The replacement selector 125 can execute the machine learning model 115 with each of the linear operations 130 replacing the first non-linear operation 210 and select one linear operation 130 to replace the first non-linear operation 210 with. The replacement selector 125 can then transform the machine learning model 115 by replacing the first non-linear operation 210 with the selected replacement operation 130. Once the model is transformed to replace the first non-linear operation 210, the replacement selector 125 can replace the second non-linear operation 210. The replacement selector 125 can identify a set of replacement operations 130 that can approximate the second non-linear operation 210. The replacement selector 125 can execute the machine learning model 115 with each of the linear operations 130 replacing the second non-linear operation 210 and select one linear operation 130 to replace the second non-linear operation 210 with. The replacement selector 125 can then transform the machine learning model 115 again by replacing the second non-linear operation 210 with the selected replacement operation 130.

Once the machine learning model 115 is transformed to generate the updated machine learning model 135, the deployer 140 can deploy the updated machine learning model 135 to the computing system 150 of the vehicle 145. The deployer 140 can include machine learning model deployment tools to deploy the updated machine learning model 135 to a vehicle platform. For example, the deployer 140 can deploy the updated machine learning model 135 to the computing system 150 of the vehicle via at least one cable, wire, connector, wireless network, cellular network, or other communication medium or channel during a provisioning phase, during vehicle servicing, via an over the air (OTA) update, or via a software update.

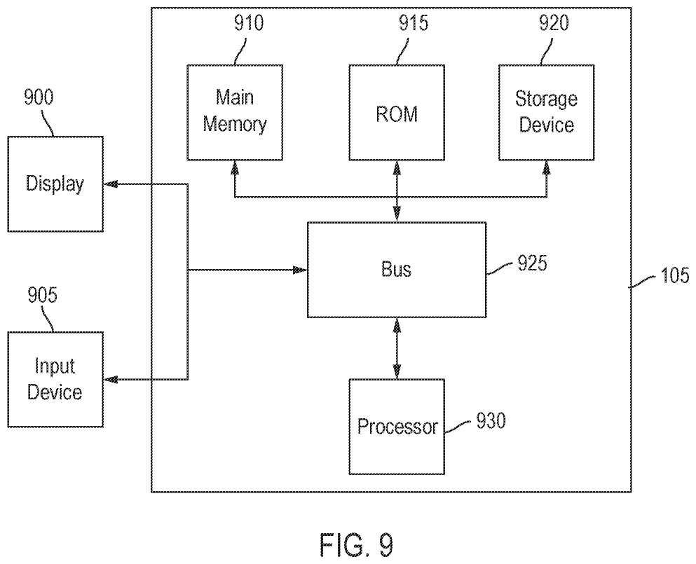

FIG. 9 depicts an example block diagram of an example computer system, computer deice, or data processing system 105. The computer environment described in FIG. 9 can be used to implement the computing system 150. The data processing system 105 can include or be used to implement a data processing system or its components. The data processing system 105 includes at least one bus 925 or other communication component for communicating information and at least one processor 930 or processing circuit coupled to the bus 925 for processing information. The data processing system 105 can also include one or more processors 930 or processing circuits coupled to the bus for processing information. The data processing system 105 also includes at least one main memory 910, such as a random access memory (RAM) or other dynamic storage device, coupled to the bus 925 for storing information, and instructions to be executed by the processor 930. The main memory 910 can be used for storing information during execution of instructions by the processor 930. The data processing system 105 may further include at least one read only memory (ROM) 915 or other static storage device coupled to the bus 925 for storing static information and instructions for the processor 930. A storage device 920, such as a solid state device, magnetic disk or optical disk, can be coupled to the bus 925 to persistently store information and instructions.

The data processing system 105 may be coupled via the bus 925 to a display 900, such as a liquid crystal display, or active matrix display, for displaying information to a user such as a driver of the electric vehicle 145 or other end user. An input device 905, such as a keyboard or voice interface may be coupled to the bus 925 for communicating information and commands to the processor 930. The input device 905 can include a touch screen display 900. The input device 905 can also include a cursor control, such as a mouse, a trackball, or cursor direction keys, for communicating direction information and command selections to the processor 930 and for controlling cursor movement on the display 900.

The processes, systems and methods described herein can be implemented by the data processing system 105 in response to the processor 930 executing an arrangement of instructions contained in main memory 910. Such instructions can be read into main memory 910 from another computer-readable medium, such as the storage device 920. Execution of the arrangement of instructions contained in main memory 910 causes the data processing system 105 to perform the illustrative processes described herein. One or more processors in a multi-processing arrangement may also be employed to execute the instructions contained in main memory 910. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the machine learning model transformation described herein can be applied to other systems besides vehicle operation and control. For example, the machine learning model transformation techniques can be applied to vehicle charging stations, vehicle chargers, vehicle design, etc. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a data processing system comprising memory devices coupled with one or more processors to:
receive a model trained by machine learning comprising a plurality of first operations, the model to generate an output to operate a vehicle;
search the model to identify a non-linear operation of the plurality of first operations;
select, from a plurality of second operations, a second operation that approximates the non-linear operation, the selection based on a level of computing resources consumed by the plurality of second operations, an accuracy of the model generated with the plurality of second operations, or an accuracy threshold to operate the vehicle; and
replace the non-linear operation with the second operation in the model to produce a second output.

2. The system of claim 1, wherein:
the second operation maps to the non-linear operation and uses less computing resources relative to the non-linear operation.

3. The system of claim 1, comprising:
the data processing system to:
receive a second model, wherein the output of the model is an input to the second model;
search the second model to identify a non-linear operation of a plurality of third operations;
select, from the plurality of second operations, a fourth operation that approximates the non-linear operation of the plurality of third operations, the selection based on the level of computing resources consumed by the plurality of second operations, an accuracy of the second model generated with the plurality of second operations, and the accuracy threshold to operate the vehicle; and
replace the non-linear operation of the plurality of third operations with the fourth operation in the model.

4. The system of claim 1, comprising:
the data processing system to:
receive a graph representing the model, the graph comprising a plurality of nodes representing the plurality of first operations of the model, the graph comprising a plurality of edges between the plurality of nodes indicating that an output of one operation of the plurality of first operations is an input into another operation of the plurality of first operations;
identify a set of nodes of the plurality of nodes to measure the accuracy at;
select a node from the set of nodes that represents an operation that operates based on the output of the non-linear operation responsive to a determination that the node is separated from a second node of the plurality of nodes representing the non-linear operation by a number of nodes or a number of edges less than a threshold; and
determine the accuracy for the plurality of second operations based on values generated by the model with the plurality of second operations at an output of the operation.

5. The system of claim 1, comprising:
the data processing system to:
replace the non-linear operation with the second operation;
execute the model with the second operation of the plurality of second operations to generate the accuracy for the second operation;
replace the non-linear operation with a third operation of the plurality of second operations;
execute the model with the third operation to generate the accuracy for the third operation;
optimize an objective function based on the accuracy of the second operation, the level of computing resources consumed by the second operation, the accuracy of the third operation, and the level of computing resources consumed by the third operation; and
select the second operation based on the optimization of the objective function.

6. The system of claim 1, the data processing system to:
train the model with a training dataset; and
select the second operation to replace the non-linear operation responsive to a completion of training the model.

7. The system of claim 1, comprising:
the data processing system to:
search a library for operations that approximate the non-linear operation to identify the plurality of second operations.

8. The system of claim 1, comprising:
the data processing system to:
execute the model with the second operation to generate at least one value at a point within the model;
determine the accuracy for the second operation based on the at least one value for the point; and
select the second operation from the plurality of second operations based on the accuracy.

9. The system of claim 1, comprising:
the data processing system to:
search the model for operations of the plurality of first operations that consume a particular level of computing resources greater than a threshold to identify the non-linear operation.

10. The system of claim 1, comprising:
the data processing system to:
search the model to identify non-linear operations of the plurality of first operations to identify the non-linear operation.

11. The system of claim 1, wherein:
the plurality of second operations are linear operations that approximate the non-linear operation.

12. A method, comprising:
receiving, by a data processing system comprising memory devices coupled with one or more processors, a model trained by machine learning comprising a plurality of first operations, the model to generate an output to operate a vehicle;
searching, by the data processing system, the model to identify a non-linear operation of the plurality of first operations;
selecting, by the data processing system, from a plurality of second operations, a second operation that approximates the non-linear operation, the selection based on a level of computing resources consumed by the plurality of second operations, an accuracy of the model generated with the plurality of second operations, and an accuracy threshold to operate the vehicle; and
replacing, by the data processing system, the non-linear operation with the second operation in the model to produce a second output.

13. The method of claim 12, wherein:
the second operation maps to the non-linear operation and uses less computing resources relative to the non-linear operation.

14. The method of claim 12, comprising:
receiving, by the data processing system, a second model, wherein the output of the model is an input to the second model;
searching, by the data processing system, the second model to identify a non-linear operation of a plurality of third operations;
selecting, by the data processing system, from the plurality of second operations, a fourth operation that approximates the non-linear operation of the plurality of third operations, the selection based on the level of computing resources consumed by the plurality of second operations, an accuracy of the second model generated with the plurality of second operations, and the accuracy threshold to operate the vehicle; and
replacing, by the data processing system, the non-linear operation of the plurality of third operations with the fourth operation in the model.

15. The method of claim 12, comprising:
receiving, by the data processing system, a graph representing the model, the graph comprising a plurality of nodes representing the plurality of first operations of the model, the graph comprising a plurality of edges between the plurality of nodes indicating that an output of one operation of the plurality of first operations is an input into another operation of the plurality of first operations;
identifying, by the data processing system, a set of nodes of the plurality of nodes to measure the accuracy at;
selecting, by the data processing system, a node from the set of nodes that represents an operation that operates based on the output of the non-linear operation responsive to a determination that the node is separated from a second node of the plurality of nodes representing the non-linear operation by a number of nodes or a number of edges less than a threshold; and
determining, by the data processing system, the accuracy for the plurality of second operations based on values generated by the model with the plurality of second operations at an output of the operation.

16. The method of claim 12, comprising:
replacing, by the data processing system, the non-linear operation with the second operation;
executing, by the data processing system, the model with the second operation of the plurality of second operations to generate the accuracy for the second operation;
replacing, by the data processing system, the non-linear operation with a third operation of the plurality of second operations;
executing, by the data processing system, the model with the third operation to generate the accuracy for the third operation;
optimizing, by the data processing system, an objective function based on the accuracy of the second operation, the level of computing resources consumed by the second operation, the accuracy of the third operation, and the level of computing resources consumed by the third operation; and
selecting, by the data processing system, the second operation based on the optimization of the objective function.

17. The method of claim 12, comprising:
executing, by the data processing system, the model with the second operation to generate at least one value at a point within the model;
determining, by the data processing system, the accuracy for the second operation based on the at least one value for the point; and
selecting, by the data processing system, the second operation from the plurality of second operations based on the accuracy.

18. A vehicle, comprising:
a data processing system comprising memory devices coupled with one or more processors to:
receive a model trained by machine learning comprising a plurality of first operations, the model transformed to replace a non-linear operation of the model with a second operation of a plurality of second operations, the second operation selected from the plurality of second operations to approximate the non-linear operation, the selection based on a level of computing resources consumed by the plurality of second operations, an accuracy of the model generated with the plurality of second operations, and an accuracy threshold to operate the vehicle;
receive sensor data from at least one sensor of the vehicle; and
execute the model with the sensor data as an input to generate an output to operate the vehicle.

19. The vehicle of claim 18, wherein:
the second operation maps to the non-linear operation and uses less computing resources relative to the non-linear operation.

20. The vehicle of claim 18, wherein:
the second operation is selected to replace the non-linear operation responsive to a completion of training the model.
